(19) United States
(12) Patent Application Publication
(10) Pub. No.: US 2002/0161826 A1
(43) Pub. Date: Oct. 31, 2002

(54) System and method for remote communication transactions

(76) Inventors: Carlos Arteaga, Suwanee, GA (US); Kip Fergusson, Clarkston, GA (US); Jamie Painter, Alpharetta, GA (US); Robert Ortiz, Cagvas, PR (US); Josean Mendez, San Juan, PR (US); Jose Carlos Estefania, Mexico (MX); Pedro Rivera, San Juan, PR (US); Charlie Jimenez, Guayhabo, PR (US)

Correspondence Address: SMITH, GAMBRELL & RUSSELL, LLP, SUITE 3100, PROMENADE II, 1230 PEACHTREE STREET, N.E., ATLANTA, GA, 30309-3592, US

(21) Appl. No.: 09/769,777

(22) Filed: Jan. 25, 2001

(51) Int. Cl. G06F 15/16

(52) U.S. Cl. 709/203; 709/213

(57) ABSTRACT

The present invention provides both a system and method for conducting remote online and offline real-time transactions on a handheld device.

### BACKGROUND

The present invention relates to both a system and method for conducting online and offline transactions on a wide variety of remote communication devices, including handheld computers, personal digital assistants (PDAs), palmtops, wireless devices, and the like.

On the heels of the Internet explosion is a new explosion in so-called “smart” handheld devices. In particular, there is a rapid movement to provide everyday users, employees and business professionals with the ability to communicate and conduct transactions wirelessly via such devices. However, the freedom to exchange data and conduct business via such remote communication devices has been, to date, limited to the ability to exchange electronic mail or access a static wireless markup language page.

The primary reason for this limitation is the need for a constant connection between the handheld device to carry out a real-time communication with a remote source. Depending, for example, on the location of the handheld user, the service status of a service provider, or the service status of the remote source, a connection may be unavailable and therefore the device unable to connect remotely. This is a particularly prevalent occurrence in the field of wireless communications. Because of intermittent communications and a lack of reliability, real-time transactions utilizing handheld devices and the Internet infrastructure has not been feasible.

A secondary reason for the limited ability of handheld devices to carry out transactions, has been the limited processing capabilities of such devices. Having significantly less memory than a desktop or laptop computer, any application or data storage must not only be compatible with the operating system of such device, but also must function within applicable memory constraints.

Accordingly, there is a need to provide a practical way for mobile handheld device users to carry out real-time transactions and communications on such devices. There is a further need to enable both real-time and asynchronous processing of such transactions with a remote source, such as an enterprise network server.

### SUMMARY OF THE INVENTION

The present invention answers the needs for practical asynchronous and real-time mobile communications and transactions by providing applications in which the logic of the developed application resides on the remote communication device, i.e., client device, thereby enabling online and offline operation.

The present invention enables real-time applications to run on a remote communication device and to receive and store data through a resident web server and resident browser on the remote communication device. By enabling local communications between the resident server and resident browser, offline communications and real-time applications can occur when the device is not connected to a desired network. When a network connection is established, a transaction and associated data can be transmitted to the desired location on the network, such as an enterprise web server for further processing.

Because the remote communication device can utilize a resident browser and hypertext transfer protocol (HTTP) to communicate with a resident web server, low-memory applications such as active server page applications or java server page applications can be maintained locally on the remote communication device. Accordingly, such applications can be called by the enterprise web server through the resident browser of the remote communications device, regardless of connection status to the network, to conduct a necessary transaction directly on the remote communication device. Further, data for such transactions can be stored until a later network connection is established for transmitting the transaction to a desired network destination, such as an enterprise's network. And unlike traditional offline transactions that utilize update cradles and thus require physical data transfer, the resident browser and resident web server architecture of the present invention allows more immediate transaction processing when a network connection, preferably a wireless network connection, is reestablished with the enterprise web server. In turn the transaction can be more quickly processed on an enterprise network to update necessary data and files within a variety of network applications.

Because the data communications of the present invention may be utilized by a wide variety of applications and systems, it is a further object of the present invention to provide multi-platform data transfer and processing capabilities. In particular, simple object access protocol (SOAP) provides a preferable transfer protocol to exchange data between a remote communication device and an enterprise network. In this regard, it is also an object of the present invention to permit data exchange in and out of an enterprise server through a combination of HTTP and SOAP transfer protocols.

A further aspect of the present invention is a resident browser modification control to enable a user's access to one or more resident browser functions to be limited. For instance, it may be undesirable for a user to have access to particular standard functions of an existing commercially available browser, such as Pocket Internet Explorer. An embodiment of the present invention enables selective customization of the browser.

Another aspect of the present invention is a hardware interface for an application running on the remote communication device to communicate with one or more hardware peripherals connected to the remote communication device. It is often desirable for a handheld remote communication device to communicate with an attached hardware peripheral such as a printer, scanner, or the like. A hardware detector and interface in the present invention permits deployment of the proper extensions and drivers to enable proper communication of a connected peripheral.

Another object of the present invention is to enable deployment and updating of files from an enterprise web server to the remote communication device. In an embodiment of the present invention one or more extractable files is packaged into a second file, such as a CABinet (CAB) file, for distribution from an enterprise web server to a desired remote communication device. When received by the remote communication device, the desired files can be extracted for carrying out operations on the device. A version controller may also be used to check a version of an application resident on the remote communication device and update it with a more recent version of the application from an enterprise web server.

It is a further aspect of the present invention to provide a security controller to prevent unauthorized access to the resident web server on the remote communication device. For example, a Windows CE web server on a remote communication device does not presently have the ability to prevent non-resident requests to the resident web server, leaving the remote communication device vulnerable to unauthorized remote access. Further, if authorized access to the resident web server of the remote communications device occurs, the remote firewall subsequently becomes vulnerable to unauthorized requests as the communication pathway will appear to be an authorized communication pathway between the remote communication device and a non-resident enterprise web server. Accordingly, a security controller is provided to prevent unauthorized access in such scenarios.

A further aspect of the present invention is a method for communicating asynchronously with a network from a remote communication device by caching a transaction destined for the network from an application running in the resident browser as an asynchronous post object in the remote communication device when the remote communication device is not connected to the network. Through a manual trigger, time interval trigger, or transaction-based trigger, the asynchronous post object may be sent to the enterprise web server on the network from the resident web server of the device when a connection is present.

Another embodiment of the present invention includes a method for persistent storage of application data for an application running on a remote communication device. When a typical active server page receives a transaction through a traditional PC browser, such as Internet Explorer or Netscape Navigator, session and application objects are created to preserve the data when a user, for instance, alternates between applications. Where a handheld browser does not provide this functionality, the present invention enables the creation of session objects and application objects for applications running on the remote communication device.

It is another object of the present invention to provide a method for generating an application for use on a handheld remote communication device. A development template for a web application creation tool is implemented for a developer to create an application for use on the remote communication device. Preferably, plug-ins are used to extend the capabilities of existing active server page and java server page creation tools to accommodate the template. In a preferred embodiment of the method of the present invention scripts created with the development template may be validated for compatibility with the handheld remote communication device on which the application will run. Preferably a deployment wizard utilizing CAB files is used to distribute the developed applications to the remote communication device.

### BRIEF DESCRIPTION OF THE DRAWINGS

FIG. 1 is a relational block diagram of the client-side (remote communication device) architecture of an embodiment of the present invention.

FIG. 2 is a relational block diagram of the development environment for an application of the present invention.

FIG. 3 is a block diagram of a client browser in an embodiment of the present invention.

FIG. 4 is a relational block diagram illustrating the processing of an asynchronous post object in an embodiment of the present invention.

FIG. 5 is a block diagram of application and session objects for an application running on a client device in an embodiment of the present invention.

FIG. 6 is a relational block diagram of version control processing in an embodiment of the present invention.

FIG. 7 is a relational block diagram illustrating the processing of a remote procedure call in an embodiment of the present invention.

FIG. 8 is a relational block diagram of database binding in an embodiment of the present invention.

FIG. 9 is a relational block diagram of security controls in an embodiment of the present invention.

FIG. 10 is a relational bock diagram of hardware and signature capture data transfer in an embodiment of the present invention.

FIG. 11 is a relational block diagram of application deployment in an embodiment of the present invention.

FIG. 12 is a relational block diagram of a SOAP parser interface for a resource connector in an embodiment of the present invention.

FIG. 13 is a directory tree diagram of an exemplary client web server directory structure in the present invention.

FIG. 14 is a flow diagram of an exemplary installation process of the present invention.

FIG. 15 is a flow diagram of an exemplary post-reboot installation process of the present invention.

FIG. 16 is a flow diagram of an exemplary execution process of a device sync page in the present invention.

FIG. 17 is a flow diagram of an exemplary execution process of a sync svr initial installation sequence in the present invention.

FIG. 18 is a flow diagram of an exemplary execution process of a sync svr normal synchronization sequence in the present invention.

FIG. 19 is a flow diagram of an exemplary SOAP call from an active server page process of the present invention.

FIG. 20 is a directory tree diagram of an exemplary remote web server directory structure in the present invention.

### DETAILED DESCRIPTION OF THE PREFERRED EMBODIMENT

For purposes of this description, the following terms are defined as follows:

ActiveX Objects—compiled code that can be dynamically referenced from an application during execution on computing platforms manufactured and sold by Microsoft Corporation, Redmond, Wash.

ADOCE—ActiveX Data Objects for Microsoft Windows CE.

Applets—Java based objects which can be dynamically referenced and executed.

ASP—Active Server Pages.

Client Device—a remote communication device.

Enterprise Application—an enterprise application is a program used by an enterprise employee that empowers them to perform their assigned tasks by allowing them to input and extract enterprise data.

HTTP (HyperText Transport Protocol)—HTTP is the communications protocol used to connect to servers on the World Wide Web. HTTP's primary function is to establish a connection with a Web server and transmit HTML pages to the client browser.

IDE (Integrated Development Environment)—tool which aids in the development of source code by providing features such as visual user interface (UI) design, debugging, and script-checking.

J-Script™—Microsoft Corporation's implementation of the JavaScript™ supporting creation of ActiveX™ objects.

JSP—Java Server Pages.

JavaScript—JavaScript is a popular scripting language that is widely supported in Web browsers and other Web tools. JavaScript is easier to use than Java, but not as powerful and deals mainly with the elements on the Web page. On the client, JavaScript is maintained as source code embedded into an HTML document.

Java Servlet—A Java application that runs in a Web server or application server and provides server-side processing, typically to access a database or perform e-commerce processing. It is a Java-based replacement for CGI scripts and proprietary plug-ins written in C and C++ for specific Web servers (ISAPI, NSAPI). Because they are written in Java, servlets are portable between servers and operating systems.

Scripting Language—Ascii text which can be embedded in an HTML page and subsequently interpreted and executed by an HTML browser.

SSJS (Server Side Java Script)—A JavaScript interpreter for running JavaScript programs on the server. SSJS includes a library of objects and functions for accessing databases, sending e-mail and performing other tasks.

SOAP (Simple Object Access Protocol)—SOAP is a protocol from Microsoft for accessing objects on the Web. SOAP employs XML syntax to send text commands across the Internet using HTTP. SOAP is supported in COM, DCOM, Internet Explorer, and Microsoft's Java implementation. Since SOAP uses HTTP and XML as the mechanisms to exchange information in a platform-independent manner, calls can get through firewall servers.

Windows CE—versions 2.11, 2.12, & 3.0 of multithreading operating system for mobile devices developed by Microsoft Corporation.

XML (eXtensible Markup Language)—XML is an open standard for describing data from the W3C. XML is used for defining data elements on a Web page and business-to-business documents. XML uses a similar tag structure as HTML; however, whereas HTML defines how elements are displayed, XML defines what those elements contain. HTML uses predefined tags, but XML allows tags to be defined by the developer of the page. Thus, virtually any data items, such as product, sales representative, and amount due, can be identified, allowing Web pages to function like database records. By providing a common method for identifying data, XML supports business-to-business transactions and is expected to become the dominant format for electronic data interchange.

The present invention provides a system and method for the communication of a remote communication device (client device), including handheld computers, personal digital assistants (PDAs), palmtops, wireless devices, and the like, to conduct both real-time and asynchronous transactions. The present invention preferably enables such devices to transfer data over a network to an enterprise web server. Although the embodiments of the present invention are described with respect to a remote communication device utilizing Microsoft Windows CE operating system and a Windows CE web server, those of ordinary skill in the art will appreciate that other operating systems and web servers may be adapted for use in the present invention.

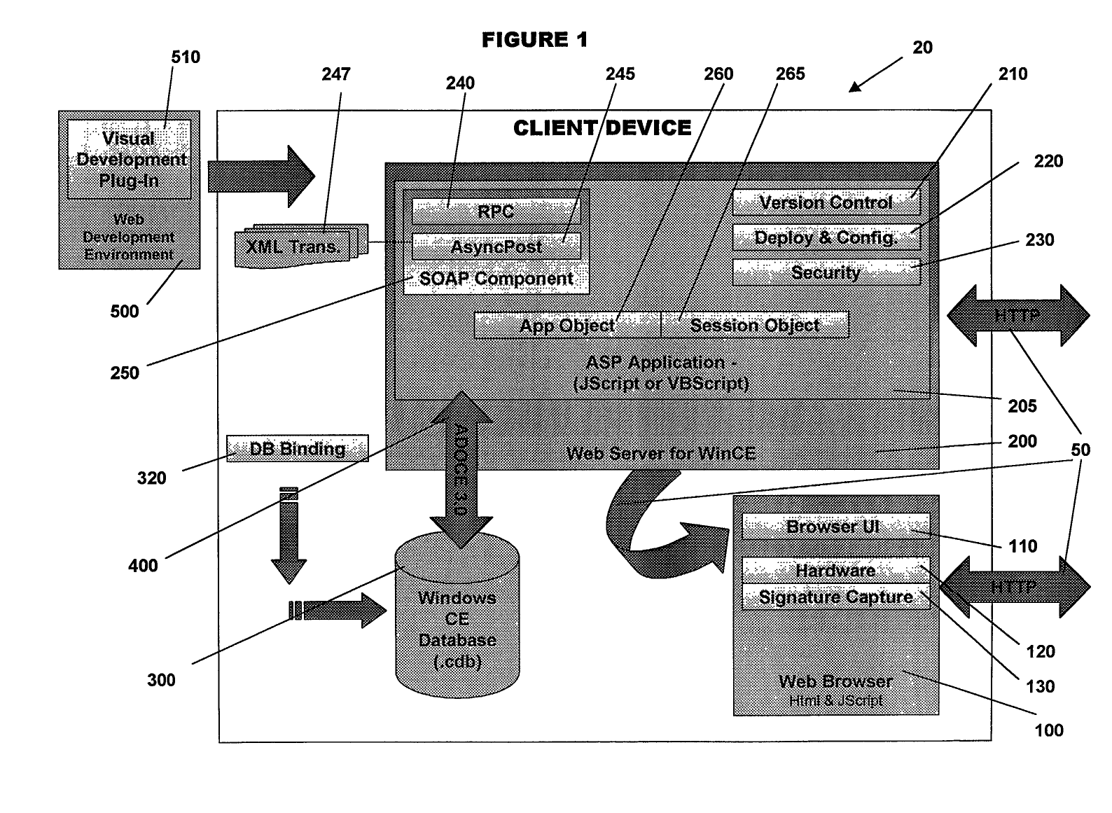

FIG. 1 shows a client-side architecture for a remote communication device 20 in the system of the present invention. The client device 20 can establish a local or network connection with a web server through a data transfer protocol 50. HTTP provides a suitable protocol for such communications, which may occur via a traditional wire connection, such as a modem and telephone line, or wirelessly.

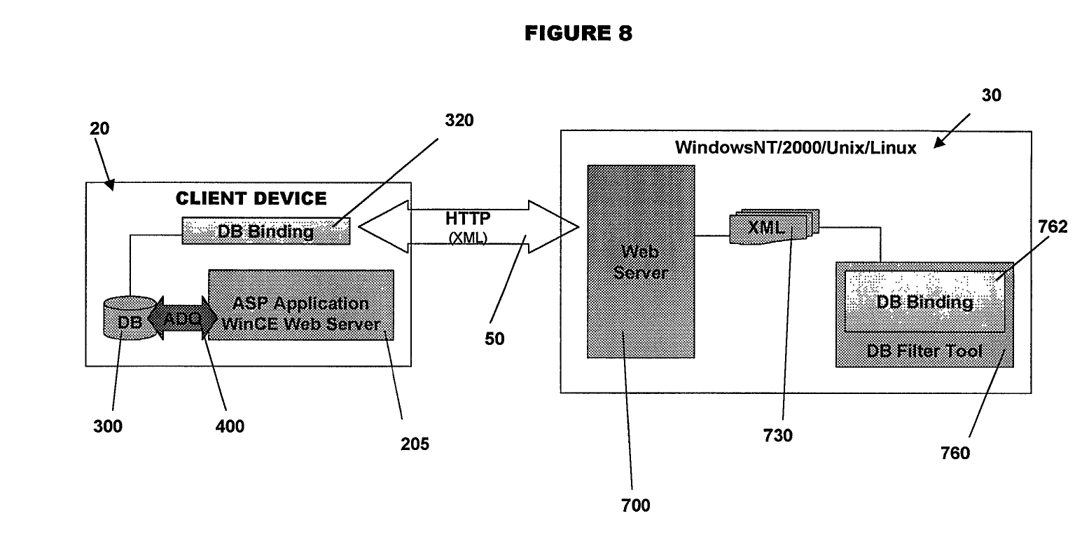

The client device 20 is provided with a resident web browser 100, such as Microsoft Pocket Explorer, capable of communications with both a network and a resident web server 200 through HTTP protocol 50. The resident browser 20 communications preferably include the ability to call Html or ASP pages, either from the resident web server 200 or from a network web server 700 (FIG. 8). Further, the resident browser 100 can call an application 205, such as an active server page, from the resident web server 200 to enable a user to conduct a transaction with the called application 205 running in the resident server 200. Thus, transactions can be carried out locally by a user of the client device 20.

The resident web server 200 is preferably for operation in the WinCE environment, thus suited for operation on a client device 20 such as a handheld computer. The resident web server 200 accepts calls for the page/application 205 from the resident web browser 100. When the desired page is called, it is returned from the resident web server 200 to the resident browser 100 for viewing and action by a user.

Data that is received or data objects called by the application 205 are transferred between the application 205 and a resident database 300 through a database interface 400. Preferably, the database interface 400 is ADOCE 3.0, and the database 400 is Windows CE compatible.

Referring to FIGS. 1 and 8, the client device database 300 is updated from the web server 700 (FIG. 8) that may operate in variety of operating systems 30, such as Windows, Unix, or Linux. Preferably, the rules and mapping for a database binding operation 762 are created by database tool 760 (FIG. 8). Database binding tool 760 is a graphical tool for creating and storing these rules, mappings, and database metadata as, for example, an XML document 730. DB Binding object 320 executes XML documents containing binding instructions to update records, delete records, create tables, delete tables, and the like, in database 300 of the client device 20. The ASP application 205 accesses the resident database 300 through ActiveX Data Objects (ADO) 400.

Database schedule executable module (abrundbsync.exe) is an executable file that, when called, executes data preparation for a given application for all registered users.

Preferably, database filter module (abdatafilter.exe) provides a tool to create a client database structure for an application and to map tables and fields for the client database from a server resident database. The database filter also provides the mechanism by which a database package can be linked to an accompanying data filtering object which has been implemented, by the application developer, to perform application and user specific transformations on data extracted by the database filter from the server resident database.

When executed, the database filter creates an XML document representing the table mappings, relationships, and filters that have been created with the tool. This XML document is later used by a data filtering object to prepare application and user specific data.

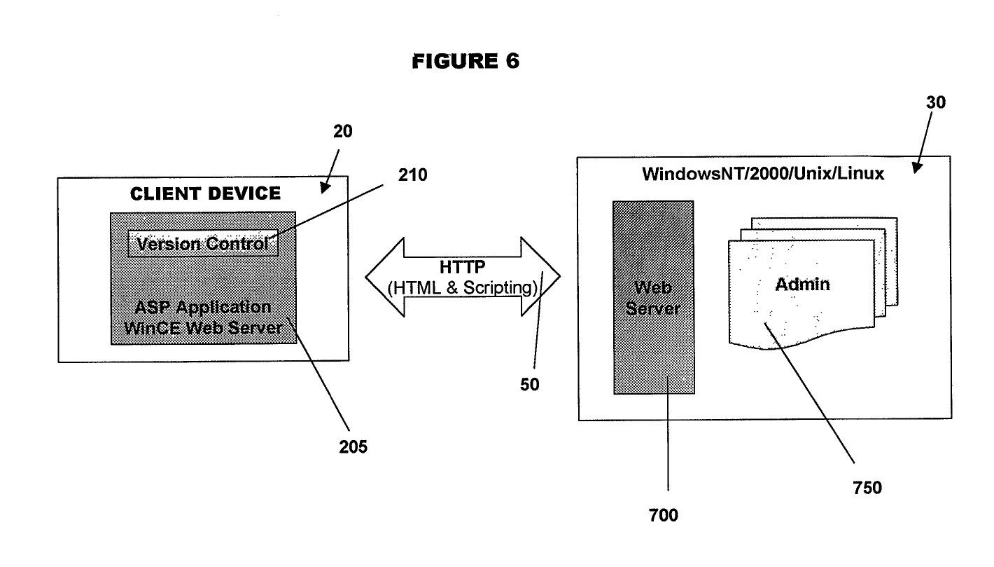

Database synchronization object module (abdbsync.dll) enables creation of a client database transformation file which will subsequently be downloaded to a device. When called, the database synchronization object opens a table created by a console component of an administrative component 750 (FIG. 6) which lists the database packages which must be run for a given application and whether these database packages are to be run by abrundbsync.exe on a schedule or run dynamically as each user synchronizes.

The database synchronization object provides a method that is called by abrundbsync.exe which retrieves all of the users from a table created by the console and for a given application creates all of the database packages which are to be run on the schedule for each user.

The database synchronization object also provides a method allowing the synchronization server to pass a username as a parameter. This method retrieves all of the applications assigned to the given user from a table maintained by the console. For each application, the method prepares the database packages which are to be run dynamically for the given user by checking a table which contains this information. Once the database synchronization object has completed preparation of database packages, the synchronization server is able to look in the directory assigned to the user for any database transformation files and prepare them for download to the device.

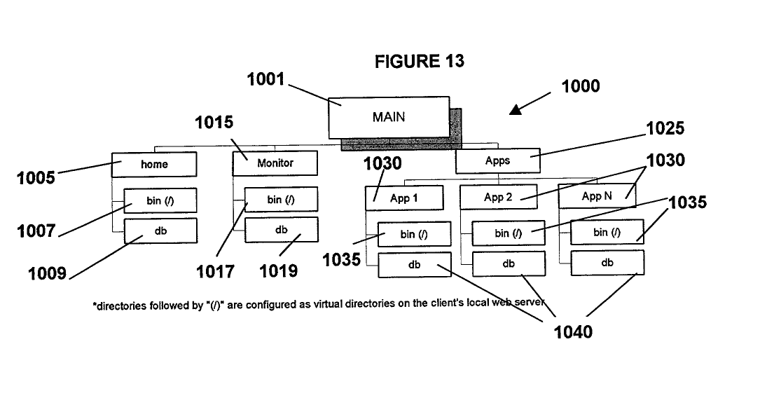

Referring to FIG. 13, all client files associated with the architecture of the present invention are located on the client device 20 (FIG. 1) using a consistent directory architecture. For Windows-powered devices, the “root” directory for the client device 20 is located in a main system directory 1001 of the “Program Files” directory of the client device 20.

Home directory 1005 for the client device 20 contains the default page for the system along with several associated pages that give the device user access to the functionality of the present invention and the applications installed on the client device 20. Exemplary associated pages are listed in Table 1:

TABLE 1

| | |
|---|---|
| Default.asp | Home page for access to system of invention |
| abapp.asp | Listing of available applications with links |
| | to start each application |
| Absync.asp | Synchronization page with information time of |
| | last sync and button to initiate sync operation |
| Abdosync.asp | Page called when ‘sync’ button is pressed |
| | which executes all synchronization tasks |

The default application (default.asp) provides the default interface. The first time the default application is run, it checks a flag to see if the device is a new device which has just installed the components of the present invention. If the device is new, it immediately runs the Synchronization Executive to install the users applications and supporting databases.

The client synchronization application (absync.asp) provides a button labeled “sync” which is used to execute a device synchronization operation. When the “sync” button is pressed the synchronization executive (abdosync.asp) is called to execute the synchronization operation. The synchronization application also provides a total of the pending asynchronous post operations and the date and time of the most recent synchronization operation.

The server module synchronization executive (abdosync.asp) is called when the synchronization button is activated on the synchronization application (absync.asp) page. The synchronization executive (abdosync.asp) performs two main tasks: (1) executes pending asynchronous post calls and (2) calls the synchronization server to perform (i) application version control, (ii) synchronization of user data, and (iii) component version control.

A virtual bin directory 1007 and database directory 1009 are also included within home directory 1005 of the client device 20.

Monitor directory 1015 contains pages which provide information on the status of the client device 20 such as battery level, memory level, and installed applications. The monitoring pages are located in their own virtual directory to allow a unique virtual path to directly access the monitoring pages from a remote browser. Table 2 provides an exemplary page included in monitor directory 1015 of the client device 20:

TABLE 2

| | |
|---|---|
| Abmonitor.asp | Page which provides status information regarding device |

A virtual bin directory 1017 and database directory 1019 are also included within the monitor directory 1015.

Through a monitoring system extension of a remote web server 700 (FIG. 6), a system administrator is able to view status information of client devices 20 from the monitor directory 1015 in real-time. A monitoring module is implemented on the network web server 700 using applets and servlets and, as a result, is accessible remotely over the web. On the client device 20, ASP pages running in the CE web server 200 respond to requests with status information regarding the client device 20. The monitoring service allows an administrator to determine which users are connected, view the battery and available memory levels of the connected devices from the respective monitor directory 1015 (FIG. 13) and view statistical information about the client device 20 and user such as the time elapsed since the last communication with the network web server 700 and the versions of applications and system components that have been installed on the client device 20.

With continuing reference to FIG. 13, Apps directory 1025 contains an application directory 1030 for each application installed on the client device 20.

In each application directory 1030, bin directory 1035 contains all web pages and associated files that comprise an application. Db directory 1040 contains any database files associated with application files in the adjacent bin directory 1035. Bin directories are configured as “virtual directories” on the client device's local web server 200 (FIG. 1) to facilitate easy navigation and file linking in applications.

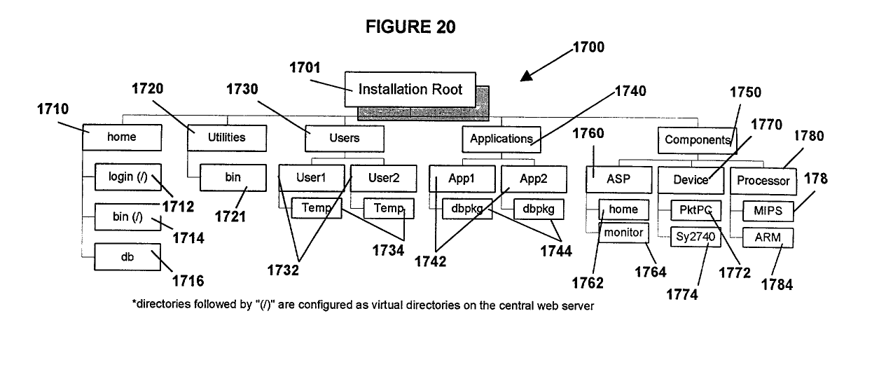

Referring to FIG. 20, the network web server 700 with which the client device 20 communicates similarly has consistent remote server directory structure 1700 with installation root 1701 to facilitate operation of the system server modules.

Home directory 1710 of the network web server 700 contains the web applications that provide access to system services and supporting files. A virtual login directory 1712, virtual bin directory 1714, and database directory 1716 are subdirectories of the home directory 1710 for the remote web server 700 .

Utilities directory 1720 of the network web server 700 contains files that are used by server modules to accomplish miscellaneous tasks such as CAB file creation. A bin directory 1721 is a subdirectory of the utilities directory 1720.

Users directory 1732 of the network web server 700 contains subdirectories for each client device user 1732 with a temp directory 1734 for each user where files are placed in preparation for download to the user's device 20.

Applications directory 1740 of the network web server 700 contains application subdirectories 1742 in which database package (dbpkg) subdirectories 1744 for each application are contained.

Components directory 1750 of the network web server 700 contains three subdirectories: ASP 1760, processor 1780, and device 1770. ASP directory 1760 contains a home subdirectory 1762 and monitor 1764 subdirectory. Processor directory 1780 contains a subdirectory 1772 and 1774 for each supported processor and any components which are dependent on the target processor. These directories also contain the web server files corresponding to each supported processor. Device subdirectory 1770 contains a folder 1782 and 1784 for each supported device and any components which must be compiled specifically for the corresponding device such as the abdevio.dll (Table 3).

Referring to FIG. 1, resident browser 100 includes a user interface (UI) component 110, a hardware component 120, and a signature capture component 130.

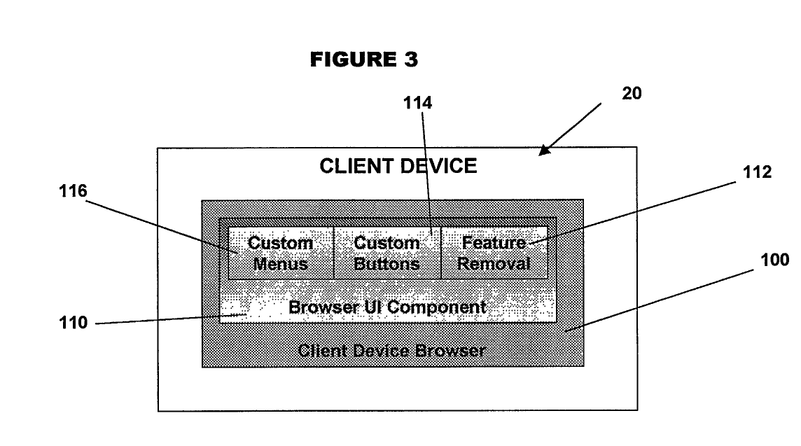

The UI component 110, depicted in FIG. 3, is a customized interface for adding and removing functionality from a third party client device browser 100, such as Pocket Internet Explorer. Feature removal 112 allows removal or disabling of a function of the browser 100. For example, it may be desirable to limit an employee's ability to access the Internet from the client device 20. Feature removal 112 thus enables unauthorized Internet access from the browser 100 to be disabled.

With continuing reference to FIG. 3, custom buttons 114 and custom menus 116 provide direct access to applications and transactional controls from resident browser 100. For example, a button calling a particular application, such as a calculation application, may be added to resident browser 100. When a user activates the button, the application is immediately called from the resident web server 200 and available for use. Accordingly, tasks are simplified by the customized menus and buttons.

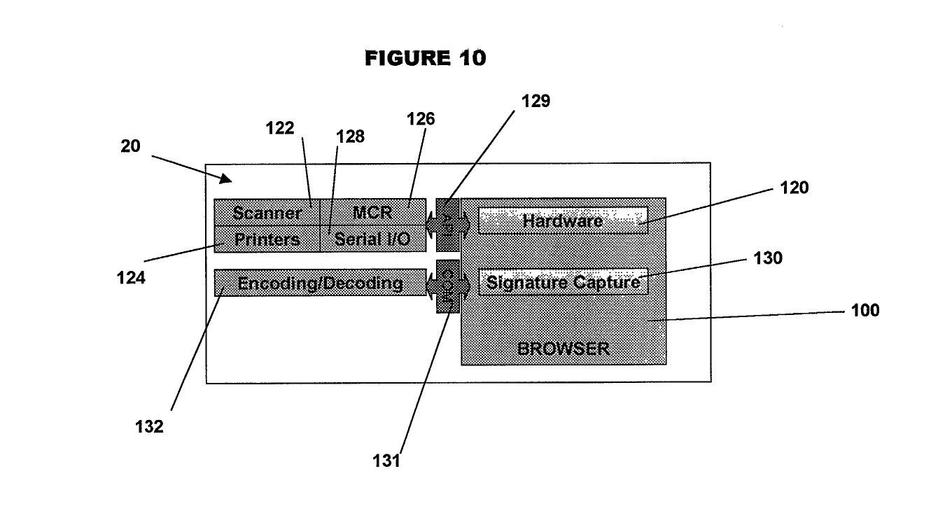

Referring to FIG. 10, hardware component 120 in client device 20 enables an application to access hardware peripherals of the client device 20. Through application program interface 129 hardware component 120 communicates with peripheral controls, such as 122, 124, 126, and 128. Exemplary peripheral controls include scanner control 122, printer control 124, magnetic card reader (MCR) control 126, and serial input/output (I/O) control 128. Scanner control 122 provides access to a barcode read, for example, connecting or installed in the client device 20. Printer control 124 supports a variety of printers through a specific printer API, depending on the printer, and an application hardware layer. MCR control 126 supports a magnetic card reader connecting or installed in client device 20. Serial I/O control 128 directly accesses the serial port of client device 20, supporting synchronous and asynchronous reading from the port.

With continuing reference to FIG. 10, signature capture component 130 enables capturing of a signature from a stylus to the client device 20. By means of component object model (COM) 131, a signature can be saved, such as a GIF format graphics file, for encoding/decoding 132 and can be transferred over a network to the web server 700 in a SOAP envelope.

Referring again to FIG. 1, resident web server 200 of client device 20 includes a version controller 210, a deployment and configuration controller 220, and a security controller 230.

FIG. 6 shows version controller 210 providing version control services for an ASP application 205, as well as other client device 20 components and files. Network web server 700 delivers applications, version updates, and necessary components via transfer protocol 50 to client device 20. In an embodiment of the present invention, a user may initiate version controller 210 to check network web server 700 for latest releases of components and applications.

Administrative component 750 on the network and operating system 30 of web server 700 enables a system administrator to create user accounts for clients, choose and configure a security policy for the system, choose the applications to be deployed to client device is 20, and specify the configuration settings of client devices 20. A console component of the administrative component 750 enables configuring and administering installation via a web interface. The console maintains several tables which contain key information about the system, such as user information, application information, user to application assignments, and the like. Preferably these tables are managed using Microsoft SQL Server. Offline applications and components are downloaded to the client device 20 via version control services 210. Administrative component 750 is preferably implemented with a Web application.

Version control 210 is the process of updating the applications that have been deployed to client device 20 and, if necessary, the ActiveX controls and/or the device web server 200. Version control 210 is initiated by the user of the client device 20 as changes made to the client device 20 configuration during version control 210 may necessitate reboot of the client device 20. The homepage/main menu application on the client device 20 has a “sync” button which will allow the user to perform many functions including version control 210. When the “sync” button is clicked the following sequence of events takes place: (1) the client device 20 transmits any pending Asynchronous Post transactions; (2) the client device 20 performs version control of the applications; (3) the client device 20 performs database synchronization; and (4) the client device 20 performs version control of the system and resident web server components. Version control and synchronization of the applications, system components, and database is initiated by the device using a SOAP request to the network web server 700. This SOAP request includes XML documents indicating the versions of applications and system components currently installed on the client device 20. Upon receipt of this request, the network web server 700 checks for any new versions of applications or components for the user and type of client device sending the request and prepares a file for any new versions for the client device 20.

For Windows-powered client devices 20, a CAB file is sent to the client device 20 in response to the version control SOAP request. This CAB file includes any new applications for the user, any updated or new system components for the device, and the database transformations necessary for the user.

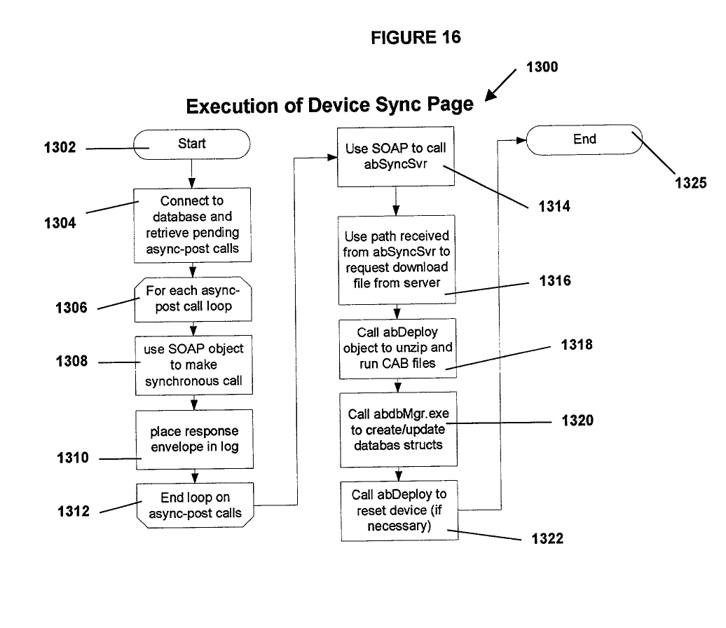

Referring to FIG. 16, execution of a device synchronization (device sync) page is shown. A device synchronization page allows the device to transfer all pending asynchronous requests stored in the device to the network web server 700, to call the synchronization server for updates to the installed components, applications and data, and to call the deployment engine in the device to run and install the updates received.

The device sync page connects to the local database 300 (FIG. 1) and retrieves all pending asynchronous post calls at step 1304. For each request retrieved at step 1306, a SOAP object is called to make the synchronous call to the network web server at step 1308. Response envelopes are written to the log at step 1310. After all asynchronous posts are executed, the device sync page sends a SOAP call to the sync server at step 1314. The path received from the call is used to request the download from the server at step 1316. A call to the deployment object in the device is made to unpack the CAB files received at step 1318. A call to the device database manager is made to create, update and/or remove database structures, and populate tables with the received data at step 1320. A subsequent call to the deployment manager is made if the updates received require a reboot of the device at step 1322.

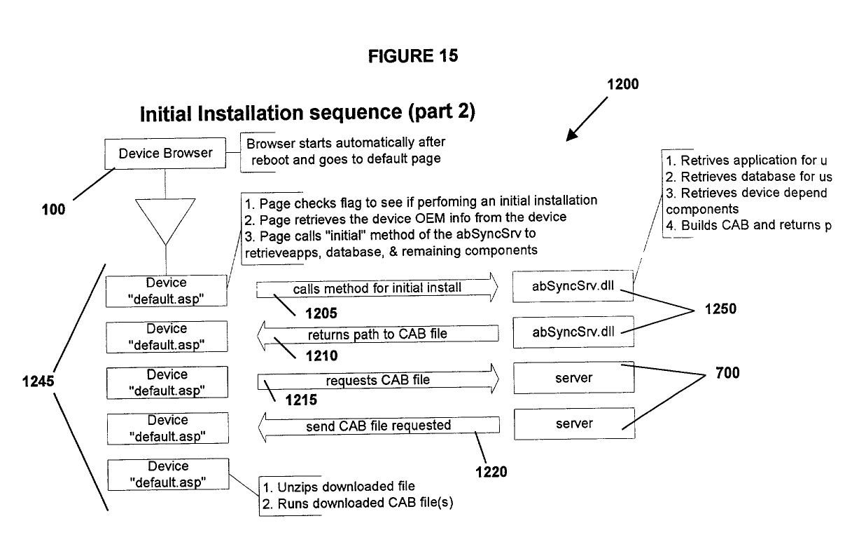

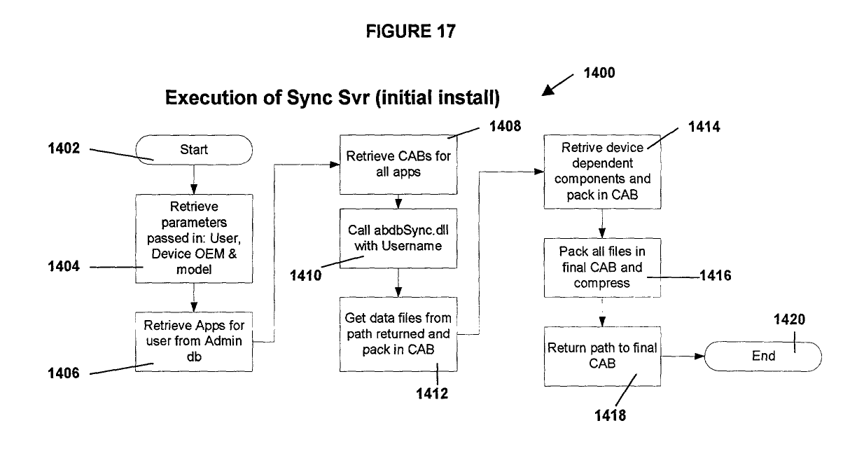

Referring to FIG. 17, execution of sync svr (absyncsrv.dll) 1250 (FIG. 15) during initial installation is shown. The synchronization server (sync svr) provides a method that is called to perform an initial install of the device specific components, applications and data in the remote device.

The synchronization server module (absyncsvr.dll) 1250 is a COM+ component that is invoked by the client synchronization application (absync.asp) to perform application version control, database synchronization, and component version control.

For initial installations, the synchronization server 1250 provides a method which retrieves the manufacturer and model of the client device 20 and the user operating the client device 20. The synchronization server 1250 uses this information to select the client device 20 dependent components for the client device 20, the applications assigned to the user, and the database setup files for the user. The synchronization server 1250 packages these files and returns them to the calling device 20.

The synchronization server 1250 looks in the folder assigned to the user performing the synchronization operation for an XML document defining the tasks which it must perform. For each application installed on the client device 20, the synchronization server 1250 checks to see if there is a new version of the application available and for the location of the new application. After retrieving all new or updated applications, the synchronization server 1250 must determine whether it must call the data synchronization executive to dynamically retrieve application data for the user or whether the application data has been previously prepared in which case the synchronization server 1250 must determine the location of the already prepared database transformation file. After retrieving the database transformation file, the synchronization server 1250 checks to see if there are any new or updated system components for the device being used and retrieves any such components as well as checks for a new configuration file for the client device 20.

After retrieving all files necessary for download, the synchronization server 1250 uses a packager module (abpackager.dll) to create a download file of all of the necessary files, places this download file in the current user's subdirectory in the temp directory, and returns this location to the client device 20 of the caller who initiated the process. Packager module (abpackager.dll) provides a method allowing a caller to set the URL of the main web server. When creating a CAB file for the default applications, this URL will be included in the CAB file and will be set in the registry when the CAB file is executed.

With continuing reference to FIG. 17, upon execution of the “initial” method at step 1402 of the sync svr 1250 by the device “default.asp” 1245 (FIG. 15), all parameters passed are retrieved (User, Device OEM and model) at step 1404. Using these parameters, the sync svr 1250 retrieves the list of applications from the admin db in the server that are specific for the user 1406. The sync svr 1250 uses this list to retrieve the CAB files of those applications at step 1408. A call is made at step 1410 to the abdbSync.dll with username to proceed to get the data required by those applications and users. The abdbSync returns a path where the files are located. The path is used to retrieve the data files and proceed to pack the same in the CAB file at step 1412. The Sync Svr then retrieves any device dependant components and pack them in a second CAB file at step 1414. All CAB files (applications, data, device specific components) are repacked and compressed in a final CAB file at step 1416. The path of the location of this CAB file is returned at step 1418. Step 1420 ends the process.

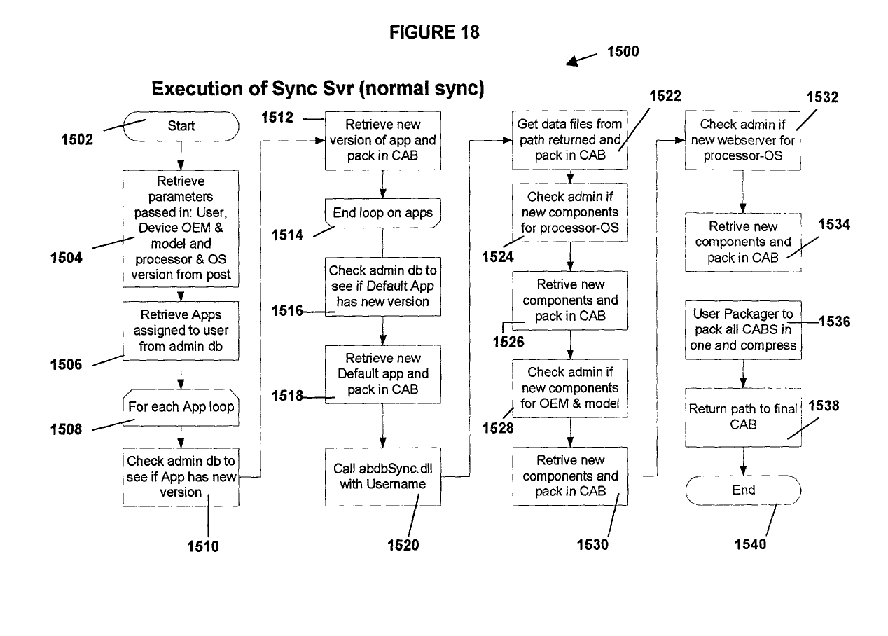

Referring to FIG. 18, execution of sync svr 1250 during normal synchronization is shown. The normal sync differs from the “initial install” in FIG. 17 in that the checks 1510, 1516, 1524, 1528, 1532 (FIG. 18) are performed to determine if the server contains updated versions of the components, applications, and data required by the remote device. Upon execution of the “normal sync” method at step 1502 of the sync svr 1250 through a device SOAP call 1314 (FIG. 16), all parameters passed are retrieved (user, device OEM, model, processor and OS) at step 1504. Using these parameters, the sync svr 1250 retrieves the list of application at step 1508, the sync svr 1250 checks the admin db for new versions of the application at step 1510. If a new version exists, the sync svr 1250 retrieves the new version of the application and packs it in a CAB file at step 1512. The sync svr 1250 checks the admin db for changes to the default application at step 1245 and 1516 (FIG. 15). If a new version exists, the new default application is retrieved and packed in a CAB file at step 1518. A call is then made to the abdbSync.dll with user name to determine data requirements at step 1520. The data files returned are then packed in a CAB file at step 1522. The sync svr 250 checks the admin db for new versions of processor or OS components at step 1524. New versions of processors and OS components are retrieved and packed in a CAB file at step 1526. The sync svr 250 checks the admin db for new versions of OEM and model components at step 1528. If a new version exists, the new components are retrieved and packed in a CAB file at step 1530. The sync svr 250 checks the admin db for new versions of the webserver for the specific OS and processor at step 1532. If a new version exists, the new components are retrieved and packed in a CAB file at step 1534. A user packager then takes all the Cab files created for the particular device and packs them in a global CAB file at step 1538.

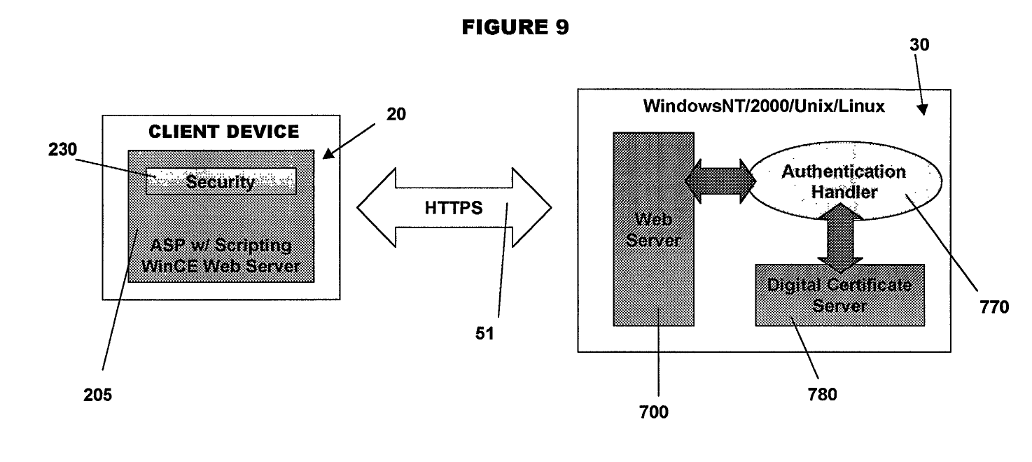

Referring to FIG. 9, a security controller 230 enforces security policy in the client device 20. Through the security administrative component, a system administrator establishes a security policy that will be consistently enforced throughout all phases of execution of the system.

The first option available to administrators of the system is whether users are allowed to initially access the system from beyond the local firewall. If the administrator chooses to prevent initial access to the system from beyond the firewall, devices which request the logon/authentication page from beyond the local area network will automatically be denied access.

The system of the present invention supports communication using both HTTP and HTTPS. The security policy in effect dictates whether normal or secure posts are used in transmissions which are controlled by the system. In the course of the application, a developer has the option to use either HTTP or HTTPS as he or she sees fit.

From network web server 700 administrators can determine whether HTTP or HTTPS protocols are required for data transmission between client device 20 and remote network operating system 30. Determination of normal or secure posts occurs via security controller 230 based on settings associated with application 205.

In an embodiment of the present invention, users may be required to have client certificates which can be authenticated by authentication handler 770. A user logging into the system will receive an installation containing a client certificate assigned to user/device by the digital certificate server 780. If security policy enforces use of security sockets layer (SSL) protocol, each transmission between client device 20 and remote web server 700 will include authentication of the client certificate by the server 700 and an authentication of the server 700 by the browser 100 (FIG. 1) of the client device 20. Through an administrative component 750, (FIG. 6) a system administrator is able to revoke client certificates if necessary and set expiration time for client certificates.

With continuing reference to FIG. 9, security controller 230 preferably controls external, i.e. non-resident requests, from outside of the network, limiting access and communication to only specified external web servers. Further, security controller 230 protects unauthorized external pages of remote web server 700 from being run from client browser 100 by an unauthorized requester, including not only the client device user, but an external request proxying through the client browser 100.

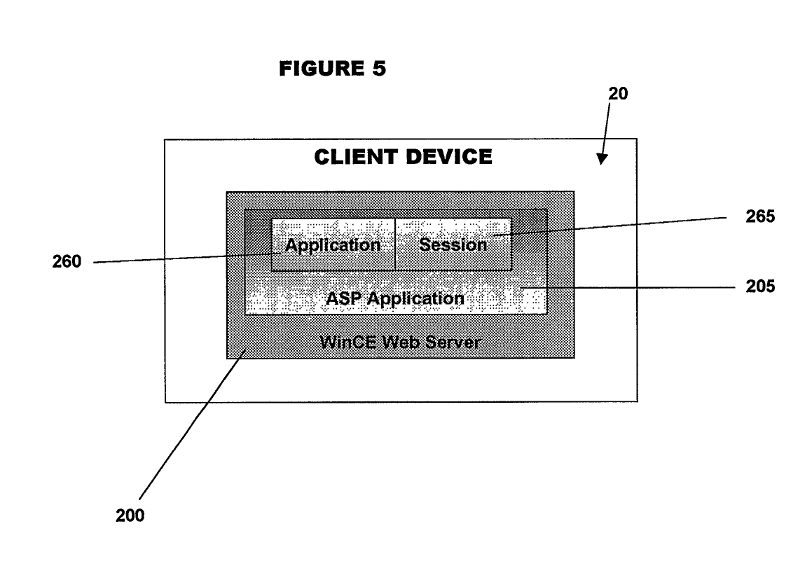

Referring to FIGS. 1 and 5, application object 260 and session object 265 for an ASP application 205 are shown. An interface for persistent storage available to resident web server 200 are made available through an application object 260 and a session object 265. Data and features associated with an application and session may be stored in the respective objects. Datatypes such as integer, string, boolean, and the like, can persist on client device 20 as a user moves between applications and/or suspends and resumes use of the device or an application. The data for the application object 260 and session object 265 will remain intact in such circumstances. Accordingly the present invention extends the capability of a client operating system, such as Windows CE, which is otherwise unequipped to provide for persistent storage of application data associated with an application object 260 and session object 265.

Referring to FIG. 1, remote procedure call component 240 and asynchronous post object 245 are communication components utilizing a SOAP envelope 250 for data transfer and communications with a remote network server 700.

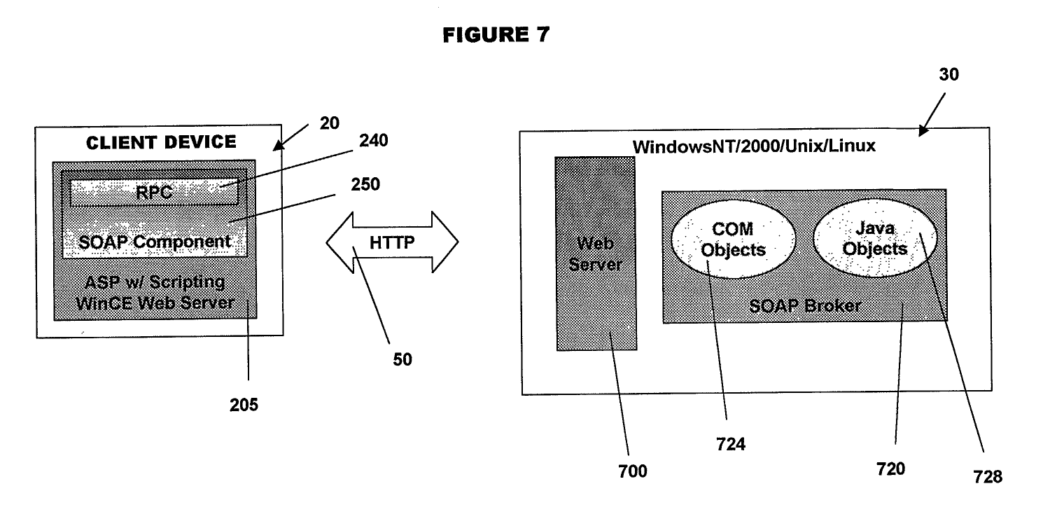

FIG. 7 shows remote procedure call component 240 providing client device 20 access to remote server-resident COM objects 724 and Java objects 728. Calling for a server-resident object is invoked from a script of the ASP application 205. If the client device 20 is offline, an error is sent in a SOAP envelope to indicate remote server status. If the client device 20 is online, remote server SOAP broker 720 reads the procedure call 240 from the MethodName header of the SOAP envelope 250 and calls the procedure and gets the response. The response from the procedure is sent back in another SOAP envelope saving the response in the HTTP body and the procedure name concatenated with ‘Response’ in the MethodName HTTP header. The MessageType HTTP header is set to CallResponse.

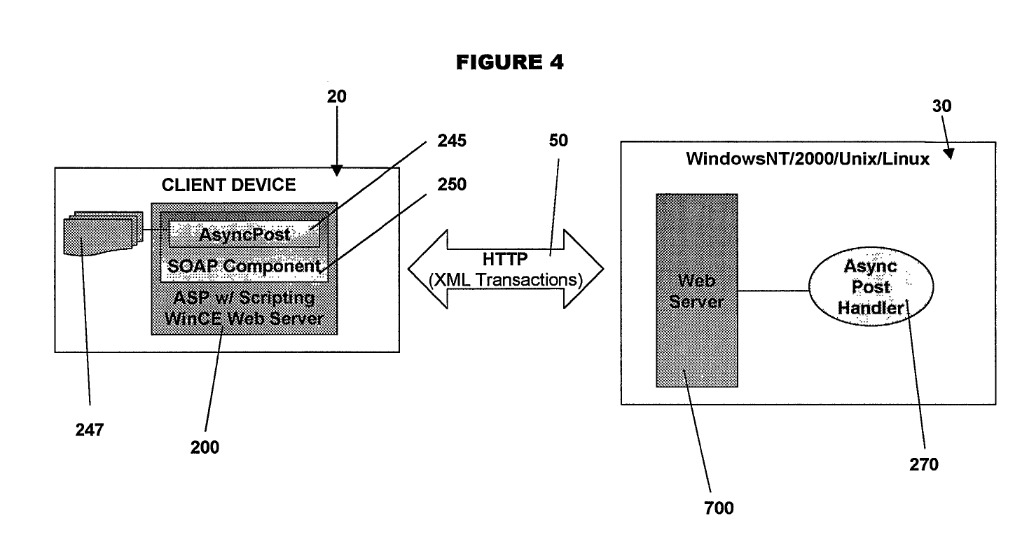

Referring to FIG. 4, an asynchronous post object 245 in the client device 20 caches a transaction 247, preferably in XML format, when the client device 20 is offline from the network web server 700. When the client device 20 is online, stored posts in a client device queue are sent to remote web server 700 in a SOAP envelope 250 containing an XML document via HTTP 50. Postings can be triggered from the client device 20 through a triggering component, including, for example, a user-activated manual trigger, a time interval trigger, or a trigger activated upon each new request being processed, i.e., a new request triggers an attempt to send all cached posts.

Server module synchronization executive (abdosync.asp) (Table 1) calls Asynchronous Post Objects on the client device 20 as queued SOAP requests and are sent by the executive from the client device 20 to the SOAP router on the main server 700. The responses from these objects are packaged in SOAP envelopes by the SOAP router and returned to the synchronization executive where the executive deposits each return envelope in the log repository. The format of the log repository is as follows: (Application Name); (Asynchronous Post ID); (Response SOAP Envelope). The Application Name is the name of the application that made the asynchronous post SOAP call. The Asynchronous Post ID is an application defined ID which is used by the application to associate the log entry with the call or transaction to which the response corresponds. The Response SOAP Envelope holds the actual XML envelope received in response to the asynchronous call that was made.

With continuing reference to FIG. 4, operating in remote operating system 30, asynchronous post handler 270 receives SOAP enveloped requests from the client device 20, and performs a transaction matching the SOAP request. In various embodiments of the present invention, the requests are handled by a user-defined transaction involving, for example, calls to an Enterprise Resource Planning (ERP) system, a database, or any other enterprise resource, and results will be sent back.

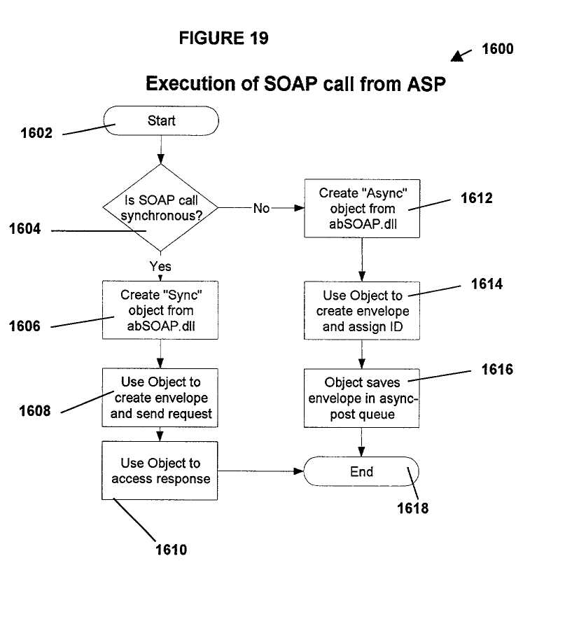

Referring to FIG. 19, an execution process 1600 of a SOAP call from an ASP 205 (FIG. 1) for generating an asynchronous post object 245 (FIG. 1) is offline or passing the request to a remote server when online is shown. A SOAP call is initiated at step 1602. Step 1604 determines whether the SOAP call is asynchronous, offline, or synchronous, online. If offline, an asynchronous object is created at step 1612 from abSOAP.dll. At step 1614 a SOAP envelope is created from the object and an identification is assigned. The object is saved in asynchronous-post queue at step 1616, ending execution at step 1618.

If synchronous/online, a synchronous object is created from abSOAP.dll at step 1606. A SOAP envelope is created from the object and sent as a request to remote server at step 1608. At step 1610 a response is accessed the remote client application from the object. Execution ends at step 1618.

Referring to FIGS. 1, 2, and 11, development and distribution of application 520 and components 610 to a client device 20 from network web server 700 is shown.

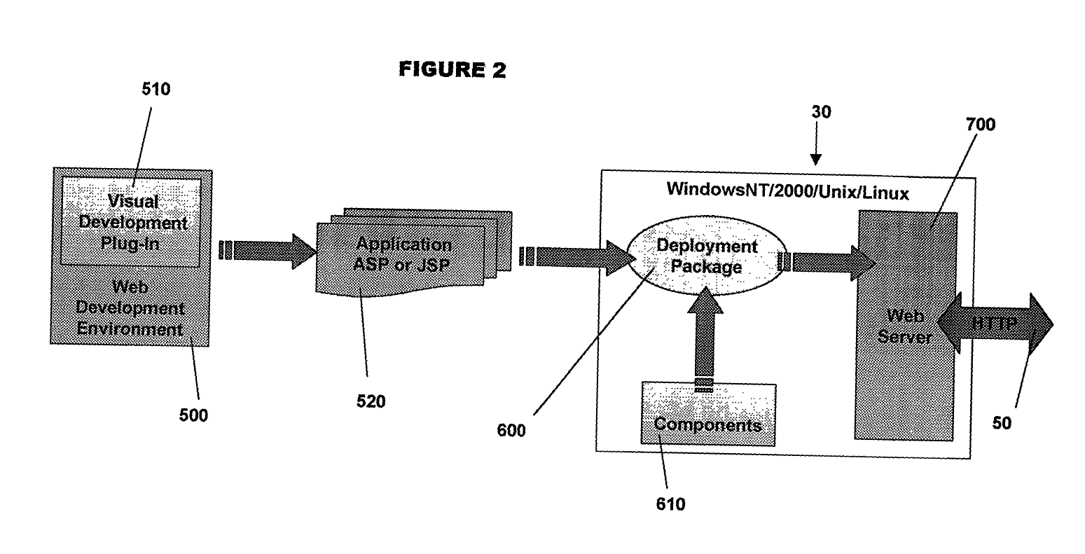

FIG. 2 shows web development environment 500, that may include, for example, standard web development tools such as Microsoft Front page 2000, NetObjects Fusion and Microsoft Visual Interdev. Visual development plug-in 510 extends a standard development tool to enable a developer to create an application 520 with attributes and functionality compatible with the client device on which the application will run. For example, screen size limitations are not adequately handled by standard web development tools, and visual development plug-in 510 enables application 520 to be optimally created for use under such limitations. Visual development plug-in 510 includes templates for use of components of the present invention, such as hardware, SOAP, and the like, in application 520. Visual development plug-in 510 also includes a script-checking component for validating compatibility of a developed application with the client device platform components.

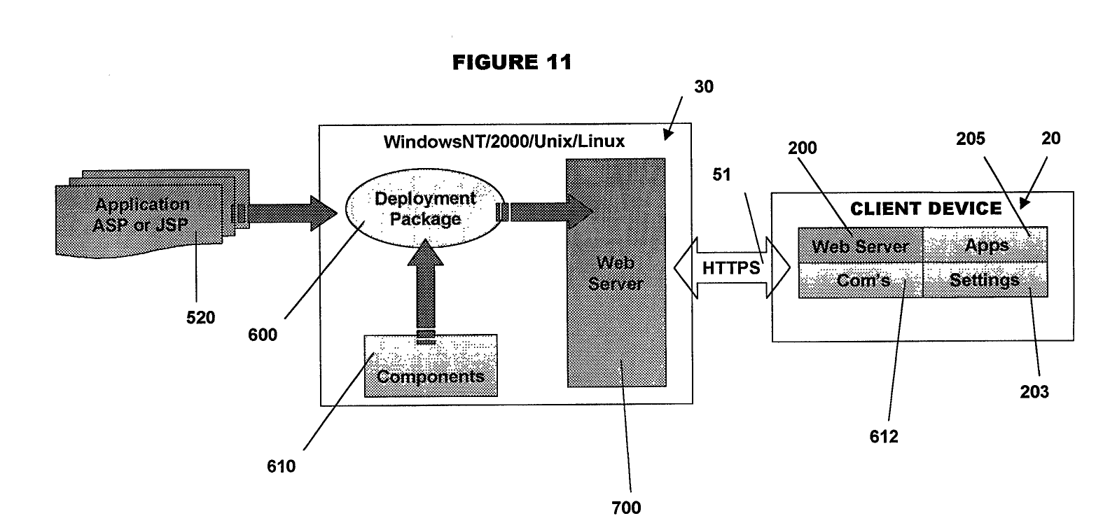

Referring to FIGS. 2 and 11, deployment of application 520 and components 610 to client device 20 via a deployment wizard is shown.

One or more applications 520 and components 610 destined for client device 20 are packaged as an extractable file into a deployment package 600. In the preferred embodiment, deployment package 600 is a CABinet (CAB) file. From network server 700 of enterprise operating system 30 and network, CAB files are deployed, preferably securely via HTTPS 51, to client device 20. By accessing a default deployment page at network web server 700 from the client browser 200, initial deployment includes client/resident web server files 205 for installation on the client device 20. Other deployed files, both initial and future distributions to client device 20, include CAB files containing extractable client components 612, client settings 203, and client applications 205. A file is extracted and installed from its respective CAB on client device 20 for resident use.

Referring again to FIG. 11, in a Windows-powered client device 20, web server 200 files are the files necessary to run Microsoft CE Web Server. These files are preferably asp.dll, httpd.dll, httpdsvc.exe and httpdadm.dll. The CE Web Server files are deployed in one CAB file 600 which is compiled for the target processor. The CAB files for the CE Web Server are stored in the “WebServers” subdirectory of the installation directory on the remote web server 700. The files are preferably named for the processors that they support, i.e., “WebServerSH3.cab”, “WebServerMIPS.cab”. The CE Web Server is deployed with a set of default settings. These settings can later be changed through an XML document that is passed to the device during synchronize operations. The CAB file which installs the resident web server sets a registry entry which is a flag indicating that the device should be reset. This flag is read by other controls after synchronization to determine when the device must be reset.

Components 612 preferably include the following files listed in Table 3:

TABLE 3

| | |
|---|---|
| Abaspex.dll | Provides extensions to ASP capabilities of |
| | standard CE web server |
| Abbui.dll | Allows browser user interface to be customized |
| | by application |
| Abconfig.dll | Reads deviceconfig.xml document and makes |
| | appropriate changes to device configuration |
| Abdbmgr.dll | Interprets database transformation XML files |
| | and executes locally on device |
| Abdevio.dll | Provides object for device specific peripherals |
| | such as scanner and magnetic card reader |
| Abdeploy.dll | Provides deployment support functionality such as |
| | resetting of device and unzipping of deployed files |
| Abinfo.dll | Provides current versions, etc. of components |
| | and installed applications |
| Absec.dll | Provides ISAPI extension for specific security |
| | of local web server |
| Abshell.dll | Provides interface to modify operating |
| | system shell |
| Absoap.dll | Provides objects to execute synchronous and |
| | asynchronous SOAP calls |
| Abstatus.dll | Provides current status of client device such |
| | as battery level, available memory |
| Abstdio.dll | Provides objects for cross-platform input/output |
| | options such as serial, printer and |
| | touch-screen capture |
| Abtapi.dll | Provides interface to telephone API of device |

Device components extend the capabilities of the device's web server 200 and browser 100 and also facilitate many specific operations on the client device 20.

ASP Extender (abaspex.dll) provides the application and session objects for ASP applications running on the client device as detailed in Table 4:

TABLE 4

| Properties | |
|---|---|
| Application.Contents: | Collection |
| Session.SessionID: | Integer |
| Session.Timeout: | Integer |
| Session.Contents: | Collection |
| Methods | |
| Application->Lock(): | Void |
| Application->UnLock(): | Void |
| Application->ContentsRemove(): | Void |
| Application-ContentsRemoveAll(): | Void |
| Session->Abandon(): | Void |
| Session->ContentsRemove(): | Void |
| Session->ContentsRemoveAll(): | Void |

User Interface Manager (abbui.dll) allows ASP applications 205 running on the client device 20 to customize the user interface of the browser 100 being used to run the application.

Configuration component (abconfig.dll) provides an interface to make configuration changes to the device operating system and to retrieve the current configuration settings as set forth in Table 5:

TABLE 5

| | |
|---|---|
| configuration->get: XMLDoc | Returns the current |
| | configuration settings of the |
| | device in an XML document |
| configuration->set(Settings): void | Configures the device according |
| | to XML document passed in Settings |
| | parameter |

Database Manager (abdbmgr.dll) performs transformations against the local client database as prescribed by the XML document delivered to the client device 20 during synchronization operations.

Deployment Manager (abdeploy.dll) performs resetting of the client device 20 and unzipping of deployed files as detailed in Table 6:

TABLE 6

| | |
|---|---|
| deploy->resetDevice(CheckFlag | Reboots the device; If CheckFlag |
| As Boolean): void | parameter is set, control checks |
| | the registry for a flag indicating |
| | reset before starting reboot. |
| deploy->unzip(RunFile As | Decompresses a ZIP file; If RunFile |
| Boolean): void | parameter is set, control runs the file |
| | after decompressing it. |

Device I/O component (abdevio.dll) provides access to device specific hardware extensions such as scanners and magnetic card readers. The version of this component deployed to the client device 20 is dependent on the manufacturer and model of the device.

Device information (abinfo.dll) component is used to retrieve the versions of the applications installed and the versions of the components of the present invention installed as detailed in Table 7:

TABLE 7

| | |
|---|---|
| XEOSInfo->XEOSVersion: | Returns version information of XEOS |
| XMLDoc | components on the device in an |
| | XML document |
| XEOSInfo->appVersion: | Returns version information of |
| XMLDoc | installed applications on the |
| | device in an XML document |

These versions are available to this component from the “manifest” XML documents which accompany each application and the system components.

Device status component (abstatus.dll) is used by the monitoring application to retrieve the current running status of the device as detailed in Table 8:

TABLE 8

| | |
|---|---|
| deviceStatus->get: XMLDoc | Returns the current status of the |
| | device in an XML document; includes |
| | battery level, free memory etc . . . |

Security filter (absec.dll) provides security to the CE web server 200. Using ISAPI filter the server is instructed to discard all requests except those coming from the local host or the central server 700.

Shell manager (abshell.dll) enables applications to modify the shell of the operating system of the client device 20.

SOAP manager component (absoap.dll) provides remote applications with two objects: SyncPost and AsyncPost that allow SOAP calls to be made from the client device 20. Synchronous SOAP calls object enables the creation and transmission of SOAP envelopes and retrieval of responses to transmitted requests as detailed in Table 9:

TABLE 9
Properties

| | |
|---|---|
| RouterURL: | string |
| The full URL of the SOAP router | |
| ForceSecure: | boolean |

If set to true, all requests will be sent using HTTPS; If set to false either HTTP or
HTTPS can be used

| | |
|---|---|
| Timeout: | integer |

The maximum amount of time to wait, in milliseconds, for a response from SOAP
request

StatusCode:

A code representing the status of the previous request.

| | |
|---|---|
| StatusDescription: | String |

A text description of the status of the result of the last call

| | |
|---|---|
| Object: | String |

The name of the object (the URI) of the SOAP object to which the method belongs

| | |
|---|---|
| Method: | String |
| The name of the method the user is calling | |
| Response: | String |
| The response from the object. | |
| ResponseType: | String |
| The datatype of the return value (Ex: “integer”) | |
| ResponseVar: | Variant |

A VARIANT containing the response converted to it's corresponding COM type. At the
time of writing, complex types are not supported. A NULL value will be present when:
a) the type is unknown b) a transmission error occurred

| | |
|---|---|
| RequestXML: | XMLDoc |
| An XMLDOMDocument object holding the request | |
| ResponseXML: | XMLDoc |

An XMLDOMDocument object holding the last response
Parameters
Add (Name,Value,Type,bEncode) - Adds a Parameter to the Request
If bEncode is true this method will Base64 encode the data in Value.
Remove (Name) - Removes a Parameter By Name
Clear () - Clears all Parameters
Count () - Returns the number of parameters in the Request Doc.
Item (Index | Name) - Returns a Parameter Record (struct)
Returns a Parameter Struct with the following fields:
Name - the name of the parameter (default)
Value - the value of the parameter
Type - the type of parameter

Methods

| | |
|---|---|
| Execute(): | Long |

Sends the request across the wire and returns an error code.

| | |
|---|---|
| Reset(): | Void |

Resets the connection object by reloading the default SOAP template. This does not
interrupt any pending transfers since all transfers are done synchronously.

| | |
|---|---|
| LoadTemplateFromSDL(): | Void |

Attempts to generate a request template via an SDL file on the server.

Asynchronous Post OPbjects provides a similar as the SyncPost object for creating a SOAP envelope but stores all envelope created where thet will remain until the next user-initiated synchronization operation.

Standard I/O component (abstdio.dll) provides access to non-device specific hardware functionality which includes: access to the serial port, capture of touch-screen input, and access to portable printers. The object supporting portable printers supports printing through the infrared port.

TAPI component (abtapi.dll) provides access to the telephone application programming interface.

For a Windows-powered device 20, the components 612 (FIG. 11) are deployed in two CAB files. There will be one CAB file for the abdevio.dll which will be compiled for each supported device and there will be a second CAB file for the remaining components which will be compiled for each supported target processor.

The CAB files for the components are stored in the “Components” subdirectory 1750 (FIG. 20) of the installation directory on network web server 700. This subdirectory has two subdirectories: “Device” 1770 and “Processor” 1780. The “Device” subdirectory has a folder, such as folders 1772 and 1774, for each supported device with the device specific CAB file (i.e. abdevio.dll cab) stored in that folder. The “Processor” subdirectory has a folder for each supported processor with the components corresponding to the processor. The CAB files for the processor-specific components are stored in the Processor subdirectory root and are named for the processors that they support (i.e. “ComSH3.cab”, “ComMIPS.cab”) For a Windows-powered client device 20 application files 205 are deployed via a platform independent CAB file 600 as shown in FIG. 2.

With continuing reference to FIG. 20, each application can consist of several files (ex: .jpg's, .asp's, .htm's . . . ). Each application has a directory in which all files comprising the application are stored. To deploy a new application or new version of an application a system administrator will use an administration controller to indicate the location of the application files and/or designate that these files have been updated. When this administrative action is performed, a platform-independent CAB file is created which will package all of the application files. This cab file is located in the “Applications” subdirectory 1740 of the installation directory on the network web server 700 and will be named according to the application name (i.e. “App1.cab”, “App2.cab”).

Application data preferably includes an XML document which includes all database transformations corresponding to a given application and user. This XML document will be interpreted by the abdbmgr.exe component on the client device 20 in order to make the necessary database modifications. Each application data XML document will be stored in the corresponding user's directory in the “Users” subdirectory 1730 of the installation directory on the network web server 700. XML documents preferably include those listed in Table 10 below:

TABLE 10

| | |
|---|---|
| Deviceconfig.xml | Created by the admin to specify configuration |
| | settings of a device |
| Database.xml | Defines the database transformations which must |
| | be performed on the device; This file is deployed |
| | to the device during synchronization |
| Manifest.xml | Supplies descriptive information about an |
| | application such as author, version etc . . . ; Each |
| | application will be accompanied by a manifest |
| | document. There will also be a manifest document |
| | for the client components. |
| Abdatapackage.xml | Output from the abDataFilter.exe which defines |
| | the database subset for the device |
| Abconnector.xml | Defines parameters for an interaction as used |
| | by Connector. |

Referring to FIG. 8, for Windows-powered device, application data XML documents 780 are deployed as a CAB file 600 (FIG. 2). This CAB file is created by the database filter tool 760 in the manner specified by the end user. When invoked, the database filter tool 760 performs the required database tasks and data preparation then updates the corresponding XML document 730 appropriately. The database filter tool 760 then packages the XML document 730 in a device independent CAB file 600 (FIG. 2).

Initial installation to the client device 20 of the present invention includes the download and installation of the system components common to all client devices.

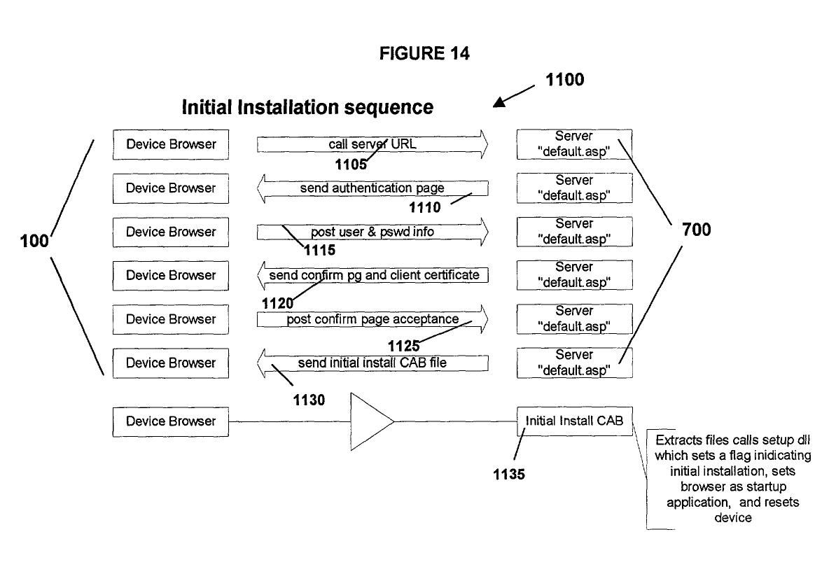

Referring to FIG. 14, initial installation sequence 1100 is shown. At step 1105 the client device user will open the client web browser 100 on the client device 20 and enter the URL of the network web server 700 extended with the services of the present invention. This request is routed to the default page.

At step 1110 the network web server 700 responds with a logon/authentication page which is delivered using SSL. The security policy in effect may prevent this page from being sent if that the policy specifies that the page will only be delivered to client devices inside the firewall and if a client requests the page from outside the firewall.

The client device operator fills the required information, including username and password, on the authentication page and sends the response to the network web server 700 using SSL at step 1115.

Upon receipt of the response from the client device 20, the network web server 700 authenticates the user with the list of valid users that have been configured through the administration application and retrieves the processor/OS/version information from the client device's post. This information is in the UA-OS and UA-CPU parameters of the post header received from the client device 20. The network web server 700 creates the client certificate for the client device 20 and sends the certificate along with a confirmation page at step 1120.

If the user accepts the confirmation page at step 1125, the client certificate is installed and the server 700 responds at step 1130 with a page containing a CAB file to install the client device CE Web Server 200 and the system components.

The CAB file, aided by a Setup DLL, installs only the system components which are processor dependent, installs the local database system, installs the client device CE Web Server, installs the default ASPs, and sets the homepage for the Pocket Internet Explorer to the client default ASP application.

The Setup DLL completes the installation by rebooting the device at step 1135.

Referring to FIG. 15, post-reboot initial installation sequence 1200 is shown.

After the reboot, the device will open the resident web browser 100 and load the default ASP page 1245. This page will read a flag indicating that a new installation is in progress.

Upon reading the flag signifying a new installation, the application will, at step 1205, invoke the server's sync-server object (abSyncSrv.dll) 1250 and call the method for completing new installations which returns the path at step 1210 to a CAB file containing the remaining items necessary to complete the installation.

The default ASP page downloads and installs the remaining items at step 1215, which includes the client applications, the device dependent system components, and the application databases sent in a CAB file at step 1220.

After completing the installation, the default ASP application returns to the client home page which allows users to select an application, if multiple applications are deployed, or, if only one application is deployed the initial page of the application will be displayed.

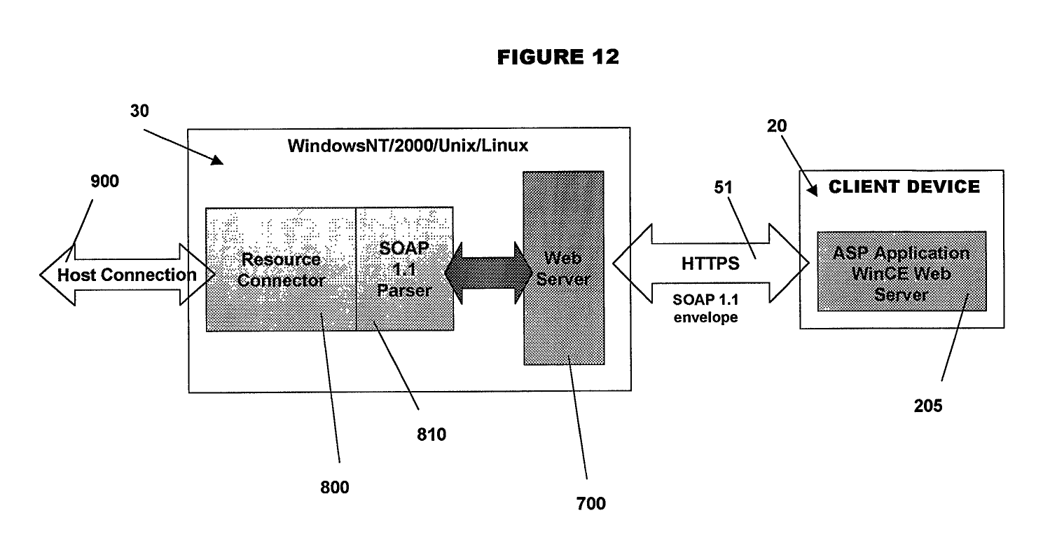

Referring to FIG. 12, an embodiment of the present invention includes an interface for data and transactions that are SOAP enveloped to access an enterprise system. A SOAP envelope is preferably securely communicated from the client device 20 to the network web server 700 preferably via HTTPS 51. Within the network operating system 30 the SOAP enveloped transaction is passed from the network web server 700 to resource connector 800 interfaced with SOAP parser 810. Preferably resource connector 800 is a Java 2 Platform, Enterprise Edition (J2EE) resource adapter, that provides connectivity to a variety of business and enterprise applications. Server module connector proxy (abconnectorproxy.dll) provides connectivity to enterprise resource planning (ERP) and other enterprise backend systems via an object model implemented using J2EE specifications for resource adapters. SOAP parser 810 enables transactions in SOAP protocol to be received and processed by resource connector 800, and, in turn, via host connection 900.

The present invention advantageously provides a cross-platform solution that supports devices and servers using the most popular operating systems in use across the world. The present invention provides a consistent development and administration framework for end-users allowing them to use the technologies with which they are most comfortable.

Preferred compatibility of the present invention with client device platforms is detailed in Table 11:

TABLE 11

| | Windows CE | EPOC | Mobile Linux |
|---|---|---|---|
| Browser | CE Web Server | Opera for EPOC | Opera for Linux |
| Local Server | CE Web Server | Java HTTP server | Java HTTP Server |
| Application | ASP & VB/J | JSP & JavaScript | JSP & JavaScript |
| Format | Script | | |
| Browser | ActiveX | JAR & Applets | JAR and Applets |
| Extensions | | | |

Preferred compatibility of the present invention with enterprise server platforms is detailed in Table 12:

TABLE 12

| | Microsoft NT/ | | |
|---|---|---|---|
| | 2000 | Unix | Linux |
| Web Server | IIS | Apache | Apache |
| Servlet Engine | Tomcat | Tomcat | Tomcat |
| SOAP Engine | MS Soap toolkit | IBM Soap Devkit | IBM Soap Devkit |

Accordingly, while the invention has been described with reference to the structures and methods disclosed, it is not confined to the details set forth but is intended to cover such modifications or changes as may fall within the scope of the following claims.

What is claimed is:

1) A communication system comprising:
a) a remote communication device;
b) a resident web server on said remote communication device;
c) a resident browser on said remote communication device; and
d) a data transfer protocol for said remote communication device to transfer data between said resident web server and a non-resident web server.

2) The communication system of claim 1 further comprising an application executed from the resident web server by the resident browser.

3) The communication system of claim 2 further comprising:
a) a database resident on said remote communication device; and
b) a data calling protocol for calling data from said database to said application.

4) The communication system of claim 2 wherein said application is selected from the group consisting of an active server page application and a java server page application.

5) The communication system of claim 1 wherein said transfer protocol includes the transfer of data in and out of a firewall protecting said non-resident web server.

6) The communication system of claim 1 wherein said transfer protocol includes the transfer of data via simple object access protocol.

7) The communication system of claim 1 wherein said resident browser includes a resident browser modification control to limit a user's access to one or more resident browser functions.

8) The communication system of claim 1 wherein said remote communication device includes a hardware interface for an application running on said to remote communication device to communicate with one or more hardware peripherals connected to the remote communication device.

9) The communication system of claim 1 wherein said resident web server includes:
a) a cache for caching a post request when said remote communication device is disconnected from the non-resident web server; and
b) an asynchronous processor for posting a cached request to said non-resident web server when said remote communication device is reconnected to the non-resident web server.

10) The communication system of claim 1 wherein said remote communication device includes database binding means for calling extensible markup language data to an application running on said remote communication device.

11) The communication system of claim 7 further comprising:
a) a hardware detector to detect a hardware peripheral connected to said remote communication device; and
b) at least one peripheral identification parameter sent from said hardware detector to said non-resident web server to identify the peripheral.

12) The communication system of claim 11 further comprising a hardware extension deployer to deploy one or more hardware extensions from the non-resident web server to the remote communication device.

13) The communication system of claim 1 further comprising a file deployer to deploy one or more files to said remote communication device from said non-resident web server.

14) The communication system of claim 13 wherein said one or more files includes an extractable first file packaged in a second file.

15) The communication system of claim 14 wherein said second file is a CABinet file.

16) The communication system of claim 1 further comprising a version controller to update an application resident on said remote communication device with a predetermined version of said application from the non-resident web server.

17) The communication system of claim 1 further comprising a security controller to prevent unauthorized access to said resident web server and said non-resident web server.

18) A method for communicating asynchronously with a network comprising:
a) providing a remote communication device for communicating with a network;
b) providing a resident browser in said remote communication device;
c) providing a resident web server in said remote communication device;
d) caching a transaction from said resident browser destined for said network as an asynchronous post object in said remote communication device if said remote communication device is not connected to the network; and
e) posting said asynchronous post object to the network from said resident web server when said remote communication device is connected to the network.

19) The method of claim 18 further comprising determining the connection status of said remote communication device before caching a transaction as an asynchronous post object in said communication device.

20) The method of claim 18 wherein posting said asynchronous post object to the network is initiated by a manual trigger.

21) The method of claim 18 wherein posting said asynchronous post object to the network is initiated by a time interval trigger.

22) The method of claim 18 wherein posting said asynchronous post object to the network is initiated when a second transaction is received by said resident web server from said resident browser.

23) The method of claim 18 wherein said transaction is an extensible markup language transaction.

24) The method of claim 18 further comprising adding a simple object access protocol envelope to said asynchronous post object prior to posting said asynchronous post object to the network.

25) The method of claim 24 wherein said posting said asynchronous post object to the network includes hypertext transport protocol delivery of said asynchronous post object to the network.

26) The method of any one of claims 18 through 25, wherein said transaction is initiated from an application running from said resident web server in said resident browser.

27) A method for executing a transaction on a remote communication device comprising:
a) providing a remote communication device with a resident browser;
b) providing the remote communication device with a resident web server; and
c) executing an application from said resident web server with said resident browser.

28) The method of claim 27 wherein said remote communication device is a handheld device with a microprocessor.

29) The method of claim 28 wherein said remote communication device is a wireless device.

30) The method of claim 27 wherein said application is an active server page application or java server page application.

31) The method of claim 30 wherein said remote communication device is a handheld device with a microprocessor.

32) The method of claim 31 wherein said remote communication device is a wireless device.

33) The method of claim 27 further comprising transferring data between said application and a resident database resident on said remote communication device.

34) The method of claim 30 further comprising transferring data between said application and a resident database resident on said remote communication device.

35) The method of claim 34 wherein said data is extensible markup language data.

36) A method for communicating data from a remote communication device to a web server comprising:
a) enveloping data from a remote communication device in a simple object access protocol envelope; and
b) transferring said data in said envelope to said web server.

37) The method of claim 36 wherein said web server is a non-resident web server.

38) The method of claim 37 wherein transferring said data in said envelope includes transfer from a resident web server on said remote communication device to the non-resident web server.

39) The method of claim 38 wherein transferring said data in said envelope includes a hypertext transfer protocol connection between a said resident web server and the non-resident web server.

40) The method of claim 39 wherein said remote communication device is a handheld device with a microprocessor.

41) The method of claim 40 wherein said device is wireless.

42) A method for persistent storage of application data for an application running on a remote communication device comprising:
a) running the application on a remote communication device;
b) storing session data received by the application as a session object; and
c) storing application data associated with the application as an application object.

43) The method of claim 42 wherein said application is executed by a resident browser resident in the remote communication device.

44) The method of claim 43 wherein said application is selected from the group consisting of an active server page application resident on said remote communication device and a java server page application resident on said remote communication device.

45) The method of claim 44 wherein the application is a first application, and further comprising:
a) switching use of the first application to a second application; and
b) resuming use of the first application with any data retained as said session object and said application object remaining intact.

46) The method of claim 42 wherein the application is a first application, and further comprising:
a) switching use of the first application to a second application; and
b) resuming use of the first application with any data retained as said session object and said application object remaining intact.

47) The method of claim 42 wherein said remote communication device is handheld device with a microprocessor.

48) The method of claim 47 wherein said remote communication device is wireless.

49) A method for deploying a file to a handheld communication device comprising:
a) determining a first file to be transferred to the handheld communication device;
b) packaging said first file as an extractable file in a second file;
c) sending said second file containing said extractable file to said handheld communication device; and
d) extracting said first file from said second file on said handheld communication device.

50) The method of claim 49 wherein the handheld communication device includes a resident browser for receiving said second file.

51) The method of claim 50 wherein said second file is CABinet file.

52) The method of claim 49 wherein said first file is determined by one or more parameters associated with said handheld communication device.

53) The method of claim 52 wherein said handheld communication device is wireless.

54) The method of claim 52 wherein said one or more parameters is selected from the group consisting of the type of the remote communication device, the operating system of the remote communication device, the type of hardware peripherals connecting to the remote communication device, the user of the remote communication device, the type of microprocessor in the remote communication device, and the version of at least one application on said remote communication device.

55) A method for controlling access to a web server on a remote communication device comprising:
a) providing a remote communication device with a resident web server; and
b) closing access to unauthorized non-resident requests to said resident web server.

56) The method of claim 55 further comprising allowing an external request to said resident web server only if said external request originates from a predetermined non-resident web server.

57) A method for generating an application for use on a handheld communication device with a microprocessor comprising:
a) providing a development template for a web application creation tool to create an application for use on a handheld communication device with a microprocessor; and
b) extending the capabilities of said creation tool to accommodate said template with one or more plug-ins.

58) The method of claim 57 wherein said application is selected from the group consisting of an active server page application and a java server page application.

59) The method of claim 58 further comprising validating a script of said application for compatibility with a platform of the remote communication device.

60) The method of claim 59 further comprising providing a wizard for creating a distribution package for deploying said application to the remote communication device.

61) The method of claim 57 further comprising providing a wizard for creating a distribution package for deploying said application to the remote communication device.
